(19) United States
(12) Patent Application Publication
(10) Pub. No.: US 2026/0252461 A1
(43) Pub. Date: Aug. 27, 2026

(54) APPARATUSES AND METHODS FOR FACILITATING AN INTELLIGENT ELECTRONIC ASSISTANT

(71) Applicant: AT&T Intellectual Property I, L. P., Atlanta, GA (US)

(72) Inventors: James H. Pratt, Round Rock, TX (US); Inderpreet Singh Ahluwalia, Austin, TX (US); Gregory W. Edwards, Austin, TX (US); Eric Zavesky, Austin, TX (US)

(73) Assignee: AT&T Intellectual Property I, L. P., Atlanta, GA (US)

(21) Appl. No.: 19/062,159

(22) Filed: Feb. 25, 2025

(51) Int. Cl. G06F 11/34; G06F 11/30

(52) U.S. Cl. CPC G06F 11/3419; G06F 11/3058

(57) ABSTRACT

Aspects of the subject disclosure may include, for example, obtaining a request, identifying, based on the obtaining of the request, parameters pertaining to the request, analyzing the request relative to the parameters to identify at least one sensor that has a capability for providing data relevant to the request, resulting in a first analysis, obtaining, based on the first analysis, at least first data provided by the at least one sensor, analyzing the at least first data relative to a baseline dataset to identify an event pertaining to the request, resulting in a second analysis, and initiating, based on the second analysis, an action. Other embodiments are disclosed.

### FIELD OF THE DISCLOSURE

The subject disclosure relates to apparatuses and methods for facilitating an intelligent electronic assistant.

### BACKGROUND

Vast communication networks and systems, and various communication devices, are used to provision communication services. Communications do not occur in a vacuum; rather, context and the environment influence the reasons why users opt or elect to engage in communications and impact the content of the communications. This is particularly true regarding emergency or first responder services, where users often have a need for detailed and accurate information to best handle or address a situation.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for facilitating an intelligent, electronic assistant that can provide information pertinent to a request or an event in conjunction with parameters (e.g., context) that are associated with the request or the event. Other embodiments are described in the subject disclosure.

One or more aspects of the subject disclosure include, in whole or in part, obtaining a request; identifying, based on the obtaining of the request, parameters pertaining to the request; analyzing the request relative to the parameters to identify at least one sensor that has a capability for providing data relevant to the request, resulting in a first analysis; obtaining, based on the first analysis, at least first data provided by the at least one sensor; analyzing the at least first data relative to a baseline dataset to identify an event pertaining to the request, resulting in a second analysis; and initiating, based on the second analysis, an action.

One or more aspects of the subject disclosure include, in whole or in part, identifying parameters associated with an occurrence of an event represented in data obtained from one or more sensors, wherein the parameters include a location of a request and a timeframe associated with the request; identifying at least a first sensor included in the one or more sensors that was active during the timeframe and has a capability in terms of coverage that includes the location; analyzing data sourced from the at least a first sensor relative to a baseline dataset to identify first data included in the data pertaining to the event; and initiating, based on the analyzing, an action.

One or more aspects of the subject disclosure include, in whole or in part, obtaining, by a processing system including a processor, an orally stated request from a user; identifying, by the processing system and based on the obtaining of the request, context associated with the request, resulting in an identified context; transmitting, by the processing system, the request in conjunction with the identified context to a server; and obtaining, by the processing system and from the server, and based on the transmitting, an identification of an event associated with the request.

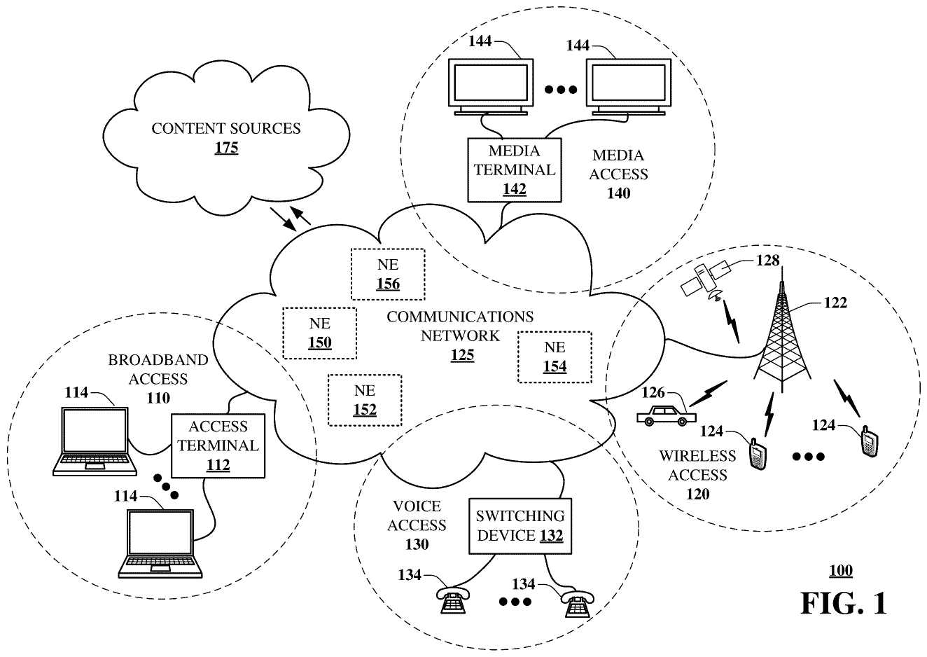

Referring now to FIG. 1, a block diagram is shown illustrating an example, non-limiting embodiment of a system 100 in accordance with various aspects described herein. For example, the system 100 can facilitate, in whole or in part, obtaining a request, identifying, based on the obtaining of the request, parameters pertaining to the request, analyzing the request relative to the parameters to identify at least one sensor that has a capability for providing data relevant to the request, resulting in a first analysis, obtaining, based on the first analysis, at least first data provided by the at least one sensor, analyzing the at least first data relative to a baseline dataset to identify an event pertaining to the request, resulting in a second analysis, and initiating, based on the second analysis, an action. The system 100 can facilitate, in whole or in part, identifying parameters associated with an occurrence of an event represented in data obtained from one or more sensors, wherein the parameters include a location of a request and a timeframe associated with the request, identifying at least a first sensor included in the one or more sensors that was active during the timeframe and has a capability in terms of coverage that includes the location, analyzing data sourced from the at least a first sensor relative to a baseline dataset to identify first data included in the data pertaining to the event, and initiating, based on the analyzing, an action. The system 100 can facilitate, in whole or in part, obtaining, by a processing system including a processor, an orally stated request from a user, identifying, by the processing system and based on the obtaining of the request, context associated with the request, resulting in an identified context, transmitting, by the processing system, the request in conjunction with the identified context to a server, and obtaining, by the processing system and from the server, and based on the transmitting, an identification of an event associated with the request.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122 (and/or via satellite 128), voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite 128 can be configured for bi-directional communication with one or more access points, with one or more base stations, and/or with one or more mobile devices (e.g., direct-to-cell). In various embodiments, the satellite 128 can comprise a Low Earth Orbit (LEO) satellite or a Geostationary Orbit (GEO) satellite.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, aspects of this disclosure may be used to address information gaps that may be present as part of provisioning communication services. In a fast-paced world, the need for accurate and timely information is of great importance, particularly in emergency situations where first responders are involved. First responders, such as police officers, firefighters, and emergency medical personnel, often face challenges in obtaining real-time, accurate data about incidents they are responding to. This lack of information can hinder the ability to make informed decisions, potentially impacting the effectiveness of responses and the safety of those involved.

Traditionally, first responders rely on communication systems that provide limited data, often requiring them to piece together information from various sources. These systems may include radio communications, dispatch information, and eyewitness accounts, which can be fragmented and incomplete. Additionally, the reliance on manual data collection and reporting can lead to delays and inaccuracies, further complicating the situation. The absence of a unified system to capture and analyze data from multiple sources in real-time presents a significant disadvantage in the current state of emergency response technologies.

Aspects of this disclosure address these, and other, challenges by introducing an approach for facilitating an electronic witness. This approach enables first responders to request and access sensor data describing an event that has already occurred, without the need for prior proactive data capture. By leveraging a network of sensors, cameras, microphones, and the like, aspects of this disclosure may collect and analyze data from the environment surrounding an incident. This data may be processed (potentially in accordance with one or more algorithms, models, technologies [e.g., artificial intelligence (AI), machine learning (ML), etc.], or the like) and delivered to the first responder, providing a comprehensive overview of the event. Thus, aspects of this disclosure may function as a conversational electronic witness, assisting first responders in making more informed decisions and improving the overall efficiency and effectiveness of emergency response operations.

The architecture or platform of the electronic assistant (which may take the form of a first responder electronic witness system in relation to first responder uses) may be designed and configured to facilitate the collection, analysis, and delivery of sensor data to first responders in a seamless and efficient manner. The architecture/platform may include a connected vehicle device, a sensor registration database, a sensor data database, a server, and sensors, as described in further detail below.

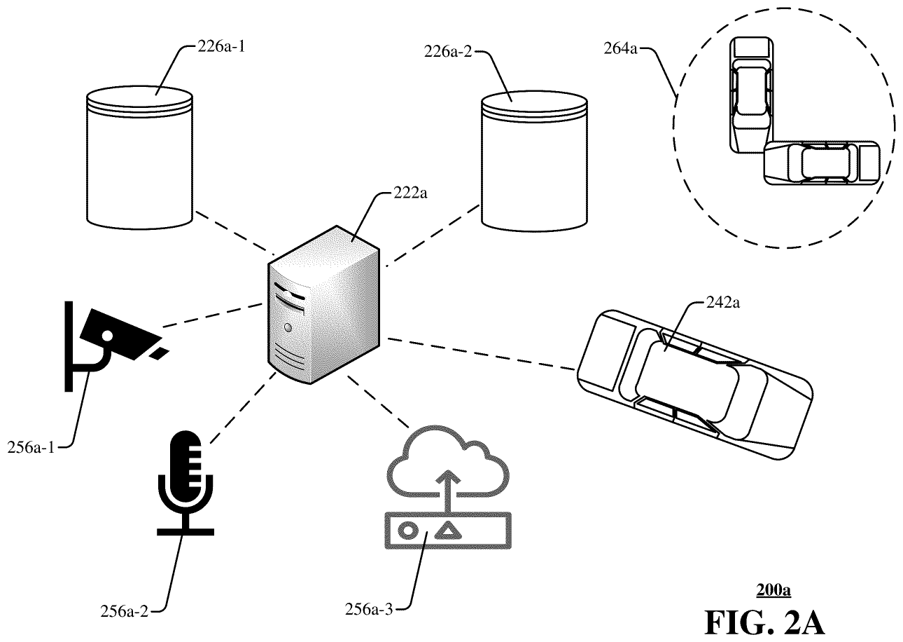

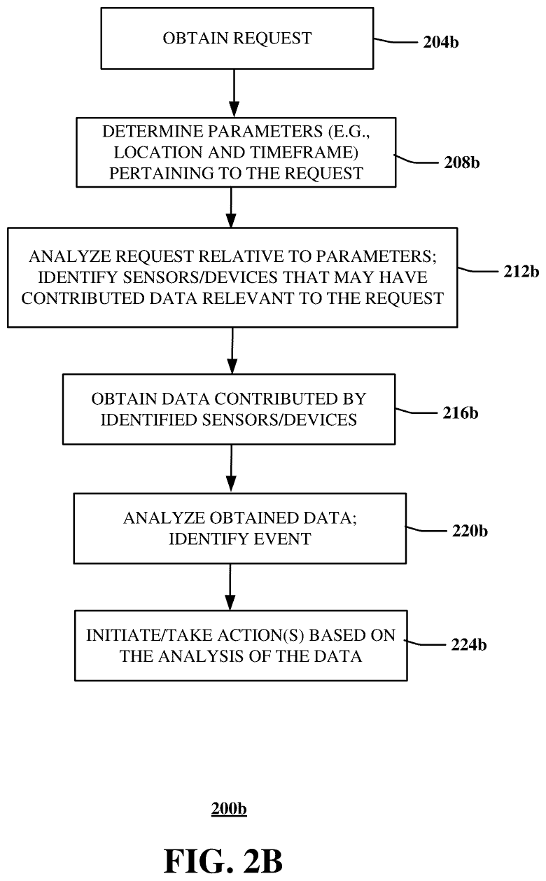

With the foregoing in mind, reference may now be made to FIG. 2A, which depicts a block diagram illustrating an example, non-limiting embodiment of a system 200a in accordance with various aspects described herein. In some embodiments, one or more parts/portions of the system 200a may be combined with, or operatively overlaid upon, one or more parts/portions of the system 100 of FIG. 1.

The system 200a may include one or more computational/computing devices, such as a server 222a, a first database 226a-1 (which may be referred to herein as a sensor registration database), a second database 226a-2 (which may be referred to herein as a sensor data database), a connected vehicle (and any associated applications and/or devices) 242a, and one or more sensors—e.g., a first sensor 256a-1 (e.g., a camera), a second sensor 256a-2 (e.g., a microphone), and a third sensor 256a-3 (e.g., an Internet of Things [IoT] device). While a server 222a is shown in FIG. 2A, it is appreciated that any type or kind of computational device(s) may be used in a given embodiment. For example, in some embodiments, a distributed computing platform or architecture, a cloud computing architecture/platform, etc., may be utilized in conjunction with what is represented by the server 222a in FIG. 2A.

The sensor registration database 226a-1 may store information about the sensors (e.g., sensors 256a-1, 256a-2, 256a-3), allowing the system 200a (e.g., the server 222a) to identify which sensors are available to report data. The sensor data database 226a-2 may obtain and store data collected from the sensors, which can be retrieved and analyzed when a user (e.g., a user associated with the vehicle 242a) requests information about a recent event. While shown separately in FIG. 2A, in some embodiments the databases 226a-1 and 226a-2 may be combined within a common housing or casing, potentially in conjunction with the server 222a.

The connected vehicle 242a may be equipped with a connected vehicle device that may include speech recognition capabilities and an application (“app”). The connected vehicle device may be location-aware and may communicate with the server 222a utilizing one or more networks and/or technologies (e.g., one or more radio access technologies).

The sensors 256a-1, 256a-2, and 256a-3 may be representative of a variety of sensors that may be located within the proximity of the user's/vehicle 242a's location. The sensors might not be directly managed by the user, but the sensors may register their availability and capabilities as part of the sensor registration database 226a-1. For example, one or more of the sensors may provide information about the capabilities provided or furnished by the sensor, including, for example, a unique identifier or address of the sensor (which may include one or more alphanumeric strings, symbols, or the like), a type of the sensor (e.g., what kind of parameters or conditions the sensor is capable of sensing), a location of the sensor (e.g., potentially as expressed as one or more coordinates in a three-dimensional space), a range of coverage of the sensor (e.g., as potentially expressed as a range in the three-dimensional space), and a status (e.g., active or inactive) of the sensor. The sensors may provide or contribute data that may be stored by/at the sensor data database 226a-2.

In some embodiments, a sensor may be operative in accordance with a push model, whereby the sensor provides data as the sensor gathers/obtains the data. A push model may be particularly useful/beneficial in embodiments where a sensor has a limited/constrained storage capacity, or where it is desired to have a wealth/depth of information available in the database 226a-2 from the sensor. In some embodiments, a sensor may be operative in accordance with a pull model, whereby the sensor provides data in response to a request for the data. A pull model may be particularly useful/beneficial in embodiments where communication channel bandwidth (or other communication resource) is limited, or where it is desirable to reduce sensor power consumption/dissipation (such as in relation to a sensor powered by a battery) by reducing the amount of transmissions that the sensor engages in.

The sensors that are active may continuously, or semi-continuously, collect data within their range. This data may include audio data, video data, motion sensor data, pressure sensor data, touch sensor data, light sensor data, temperature sensor data, wind sensor data, and other relevant information. The data may be analyzed to establish (a set of) baseline conditions, which may be used for comparison when an event or incident occurs.

In operation, a user (e.g., a first responder associated with the vehicle 242a) may request an analysis of data describing an event. For example, it may be the case that, in relation to the event, the user heard a loud noise and may utter an expression such as “What was that?” in surprise. Based on detecting this speech/utterance from the user, the app may translate the expression to a request for information pertinent to some event that happened recently or within some unspecified threshold amount of time (e.g., within the last 10 seconds). Thus, the request may include a specification of various parameters, such as the user/vehicle 242a location and a timestamp of when the expression was uttered (potentially in combination with other parameters that may be pertinent to the request, such as an orientation or direction or speed of travel of the user or the vehicle 242a). The parameters may be used to set guidelines for identifying sensors that may be relevant to the uttered expression (in terms of geographical range, for example) and how far back in time relevant data may be present.

The server 222a may obtain the request from the app associated with the vehicle 242a. The server 222a may compare the parameters of the request with the (data/information of the) sensor registration database 226a-1 to determine/identify those sensors that were active or generating data over the relevant time frame (e.g., 15 seconds) in the lead-up to the event, with capabilities that may have been sufficient to contribute/provide data that may be relevant to the event. Next, the server 222a may poll or request the sensor data database 226a-2 to provide data corresponding to the sensors that were determined/identified as being active and in proximity to the event (e.g., capable of being within a range of coverage of the event) in conjunction with the sensor registration database 226a-1. Based on the same, the server 222a may acquire the data from the sensor data database 226a-2. Based on acquiring the data from the sensor data database 226a-2, the server 222a may perform an analysis (potentially in conjunction with one or more algorithms, models, technologies (e.g., AI and/or ML), or the like) to identify an anomaly or outlier in the data that may help to explain the event that transpired. As part of the analysis, one or more thresholds may be selected and/or utilized as a basis for comparison to determine whether data lies within a range of normal variation in terms of baseline data, or whether the data is representative of the event.

It is noted that the app (potentially in conjunction with analysis/analyses provided by the server 222a) may be configured to request additional information from the user to help identify or confirm the event in question. Continuing the above example, it may be assumed that the loud noise that the user of the vehicle 242a heard was a result of an accident involving two or more vehicles, such accident fairly being represented by the collision 264a depicted in FIG. 2A. The analysis of the data performed by the server 222a may have identified the (audio of the vehicles contacting one another as part of the) collision 264a as substantially corresponding to a loud noise that may be tied or related to the uttered expression “What was that?”. Based on the analysis, the server 222a may coordinate with the app to have the app respond to the user with a statement or counterpart expression, such as “I heard a loud bang. Is that what you mean?” In response to the counterpart expression, the user may confirm/state “Yes”, and in turn and based on the confirmation, the app (by way of the server 222a) may indicate to the user (by way of an analysis of sensor-based video data that) “I saw a car wreck two blocks away from you to the north”. Based on this information that the user obtains from the app, the user may navigate northbound to the site of the collision 264a. In this regard, the app may furnish navigation instructions to enable the user to drive the vehicle 242a to the site of the collision 264a. In embodiments that support autonomous vehicles/autonomous vehicle operations, the vehicle 242a may be automatically re-routed to the site of the collision 264a. Upon arriving at the site of the collision 264a, and based on an analysis of the (sensor) data, the user/first responder associated with the vehicle 242a may be provided with a set of directions or instructions on how to best handle or address the collision 264a.

What the foregoing example pertaining to the collision 264a demonstrates is that the connected vehicle device and app of the vehicle 242a, working in concert with the server 222a (and the databases 226a-1 and 226a-2) may be able to provide what may be referred to herein as an electronic witness. Traditionally, a user (e.g., a first responder) might respond to a collision or accident (or more generally, an incident) based on a call received by a call or dispatch center. Next, upon arriving at the site of the incident the first responder may have to gather information pertinent to the incident. Such information gathering techniques may include interviewing persons/witnesses that profess to have observed the incident (or profess to have knowledge pertaining to material facts associated with the incident). It is noted that witnesses may intentionally fabricate information (potentially for nefarious or improper purposes, such as to reduce the likelihood of being found responsible or at fault) or may misconstrue/misperceive what has transpired (perhaps due to forgetfulness or emotions triggered by witnessing an incident), which is to say that the first responder may have to question the credibility or veracity of any statements that may be provided by witnesses. All of these traditional/conventional techniques pertaining to information gathering/collection take time, and as noted above, may be of questionable validity/accuracy. In contrast, aspects of this disclosure may be utilized to provide pertinent/relevant information to a first responder regarding an incident. To demonstrate, and continuing the above example, upon arriving at the site of the collision 264a, the app may present to the user of the vehicle 242a a video of the moments leading up to the collision 264a (as potentially captured by the camera 256a-1, for example). The video may be analyzed by the user to identify potential injuries that may have been sustained by people inside the vehicles involved in the collision 264a.

As demonstrated via the example set forth above pertaining to the collision 264a, and the user/first responder associated with the vehicle 242a, the system 200a (inclusive of the server 222a, the databases 226a-1 and 226a-2, the sensors 256a-1, 256a-2, 256a-3, and the app/connected vehicle device associated with the vehicle 242a) may provide intelligence to enable the user/first responder to engage in a conversation to obtain information that may be relevant to a discharge of the duties of the user/first responder. Furthermore, as the data/information that is provided to the user/first responder may lack an element of human bias, the data/information that is furnished to the user/first responder may be highly accurate and trustworthy. Also, data/information that is provided to the user/first responder may be provided in short time frames (e.g., on the order of a few seconds), which can be an essential element in practical applications involving the provisioning of first responder services in emergency situations. In this regard, aspects of this disclosure represent substantial improvements to technologies associated with a provisioning of communication services, particularly in respect of emergency/first responder services/situations.

A capture of data may help to facilitate a later analysis for any number of purposes. For example, and in relation to the collision 264a shown in FIG. 2A, aspects of the data may be used to effectively model or recreate the collision 264a in conjunction with assigning/attributing cause/fault for the collision 264a, processing insurance claims, or the like. In this regard, aspects of this disclosure may be operative in conjunction with techniques described in U.S. patent application publication number 2024/0086463, the contents of which are incorporated herein by way of reference. The model or recreation of the collision 264a may be incorporated as part of instructional material, such as a presentation that may be provided to a driver's education (“Driver's Ed”) class on how to operate a vehicle to reduce (e.g., avoid) collisions. Still further, the model or recreation may be utilized to train first responders on a use of the app/connected vehicle device, which may incentive further adoption/use of the app/connected vehicle device. In this regard, it is understood and appreciated that as more users/first responders utilize the technology, the algorithms, models, and the like supporting the technology, the technology may become more accurate over time in terms of decision-making processes/logic. In turn, any errors that may be present may tend to converge towards zero in time/with use, which may encourage even further adoption/utilization.

The data/information associated with an event may be saved/stored as part of a record. For example, a user/first responder may cause the record to be generated or saved via a user-generated input, such as a user command “Save that” that the user/first responder may utter.

Based on the foregoing example embodiment shown and described above in respect of FIG. 2A, it is appreciated that aspects of this disclosure provide solutions that enable a first responder (or more generally, a user) to request and obtain sensor/sensory data/information describing an event that has occurred, along with any analyses that may be applied to that data/information. The first responder need not have been proactively requesting a capture of the data/information at the time that the event occurred/transpired, which is to say that the data/information may have been captured in advance of when the data/information is effectively requested/solicited by the first responder. For example, and after arriving at a site/scene of an incident, a first responder may retroactively request data/information, such as video or audio, captured of the event. Analysis of the data/information may be performed and provided/sent to a communication device of the first responder. Thus, aspects of this disclosure be used to provide/generate a conversational electronic witness to assist first responders in a discharge of their duties.

By virtue of the expression uttered by the user (namely, “What was that?”) in the example above that initiated the data/information retrieval/analysis, it is understood and appreciated that the technology of this disclosure enables an intelligent data/information retrieval and analysis to occur with relatively limited user inputs being supplied/provided. Stated differently, aspects of this disclosure may be utilized to fill-in or supply context to interactions involving users (e.g., first responders), which in turn may alleviate the users from the burden of having to supply such context and may enable the users to focus on other tasks (e.g., operating the vehicle 242a in the example described above). Further, it is noted that in some instances users/first responders may lack knowledge to furnish/provide such context. To the extent that the analysis identifies any context (or other information) that may be lacking that may be able to be supplied by a user, the technology of this disclosure may solicit the same from the user. In this respect, aspects of this disclosure may be utilized iteratively to refine inputs or outputs that influence decision-making processes or logic and may involve users to the extent that such users wish to be involved.

While various aspects of the example described above may pertain to a use of the technology of this disclosure for first responder or emergency purposes, it is appreciated that aspects of this disclosure may be utilized or applied as part of other practical applications. For example, if a couple is out to dinner at a restaurant and a first member of the couple initiates a marriage proposal directed to a second member of the couple, one or both of the first member and the second member of the couple may wish to save/store a record of memories related to the marriage proposal. In this regard, it may be possible to save/store a record of the events leading up to the proposal, potentially from the time that the couple entered the restaurant until the second member of the couple (hopefully) accepted the proposal. Further, it may be possible to save/store for the record of memories the moments after the proposal, such as a kiss that may occur between the first and second members of the couple. Aspects of the system 200a (for example, the server 222a, the databases 226a-1 and 226a-2, and the sensors 256a-1, 256a-2, and 256a-3, where the sensors 256a-1, 256a-2, and 256a-3 may be located in the restaurant in this example) may be adapted to capture data associated with the restaurant and provide a focus on the couple in relation to the event of the engagement proposal and acceptance.

In another context, it may be the case that a first user is walking along a sidewalk and observes a second user carrying a decorative purse/handbag that the first user wishes to have for herself. The first user may utter an expression, such as “Buy that” that may be perceived/received by a (microphone of a) mobile device of the first user. Based on the same, in conjunction with sensor data that may be captured in respect of/near the first user, it may be understood or inferred that the first user was likely referring to the handbag of the second user. The first user's mobile device may present a request for confirmation, such as “Is the handbag that was yellow and black the item you were referring to?”. The first user may confirm that it was, in fact, the handbag by saying “Yes”. The technology of this application may then be able to identify a source for purchasing the handbag (based on characteristics of the handbag that may have been captured via sensor data) and may facilitate the purchase from the source using a credit card (or other means of payment) that the first user may have on file. As this example demonstrates, the first user's life may be made very easy, and from the perspective of merchants, opportunities may be provided/generated to support (impulse) buys/purchases of products or services from potential customers.

Referring now to FIG. 2B, an illustrative embodiment of a method 200b in accordance with various aspects described herein is shown. The method 200b may be implemented or executed, in whole or in part, in conjunction with one or more systems, devices, and/or components, such as for example the systems, devices, and components set forth herein. In some embodiments, the method 200b may be wholly or partially implemented or executed via one or more processing systems, where each such processing system may include one or more processors. Further, in some embodiments, operations of the method 200b may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200b are described below in relation to the blocks shown in FIG. 2B. In some embodiments, one or more blocks or operations may be based on one or more other blocks or operations.

In block 204b, a request may be obtained. For example, the request may be obtained based on a user-generated input, such as speech (e.g., “What was that?” or “Buy that” in the examples above).

In block 208b, a determination may be made regarding a location of the request (or, analogously, a location of the user) and a relevant timeframe pertaining to the request. In some instances, a user may specify a location or timeframe that is to be associated with the request; in other instances, the timeframe may be inferred based on context (or other parameters) associated with the request.

In block 212b, the request (of block 204b) may be analyzed relative to the context and parameters (of block 208b) to identify those sensors or devices that are registered that were active and have capabilities that may result in the sensors/devices having contributed/collected data that may be relevant to the request.

In block 216b, data that was contributed/provided by the sensors/devices that were identified as part of block 212b may be obtained.

In block 220b, the data that was obtained as part of block 216b may be analyzed. The analysis of block 220b may be facilitated by one or more algorithms, models, technologies (AI or ML), or the like. The analysis may serve to identify an event that may have occurred in respect of the request (of block 204b). For example, the event may have occurred prior to the request and may have triggered or initiated the request in the first instance. The event may be represented in the data as an outlier or an anomaly relative to a baseline that may be present in the data/dataset.

In block 224b, one or more actions may be taken or initiated based on the analysis of block 220b. For example, if additional information is needed from a user in conjunction with the request, such information may be solicited. Block 224b may include saving or storing a record associated with the request (and any event that may be identified as part of block 220b). Block 224b may include sending a report to a user (or associated communication device) that includes the analysis of the data and potentially a recreation of the event as captured by/within the data. Block 224b may include initiating a purchase (or engaging in some other transaction, like a data or communication transaction) related to the time of the occurrence of the request (or event).

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Aspects of this disclosure may provide security or privacy in respect of (sensitive) data or information. For example, aspects of this disclosure may utilize a credentials-based approach (e.g., a username and password, a personal identification number [PIN], a biometric credential, etc.) to conditionally: grant access to data/information, enable a distribution/dissemination of data/information, enable an editing of data/information, etc. In this respect, facts or circumstances pertaining to an incident might not be able to be tampered with, and the integrity of any investigations involving an incident may be enhanced or preserved.

The foregoing examples demonstrate that aspects of this disclosure may support an electronic assistant that may have sufficient intelligence or logic to provide relevant information to a user based on an analysis of data that may be contributed/provided by one or more sensors or devices. Inputs and outputs that may be generated may be presented using one or more interfaces to facilitate user engagement. For example, a first user may prefer to engage via a speech-to-text technology (with oral statements/speech being provided), whereas a second user may prefer to utilize a graphical user interface. Aspects of this disclosure may be adapted to accommodate user preferences in relation to the presentation of information as part of/in conjunction with the electronic assistant.

As demonstrated herein, aspects of this disclosure may be integrated as part of numerous practical applications involving communication services and sessions. Aspects of this disclosure may be used to identify relevant or pertinent information, based on context associated with one or more requests. In some embodiments information or data that is potentially identified as material or relevant (relative to one or more thresholds) may be pushed or provided to a user in the absence of an explicit request for the same. Stated slightly differently, and in the context of a crime that may be in progress, a user (e.g., a police officer) might not necessarily even be aware that something improper is occurring. However, a automated monitoring of sensor data may be able to identify the crime in progress and may initiate police action before the perpetrators are able to get away or escape. In this regard, and as this example demonstrates, aspects of this disclosure may be utilized in a proactive manner or fashion to provide recommendations or suggestions for taking some action, potentially in advance of any harm befalling a user or other person or property.

As the foregoing demonstrates, the various aspects of this disclosure are not directed to abstract ideas. To the contrary, the various aspects of this disclosure are directed to, and encompass, significantly more than any abstract idea standing alone, resulting in improvements to technology and generating a multitude of useful, concrete, tangible, and transformative results.

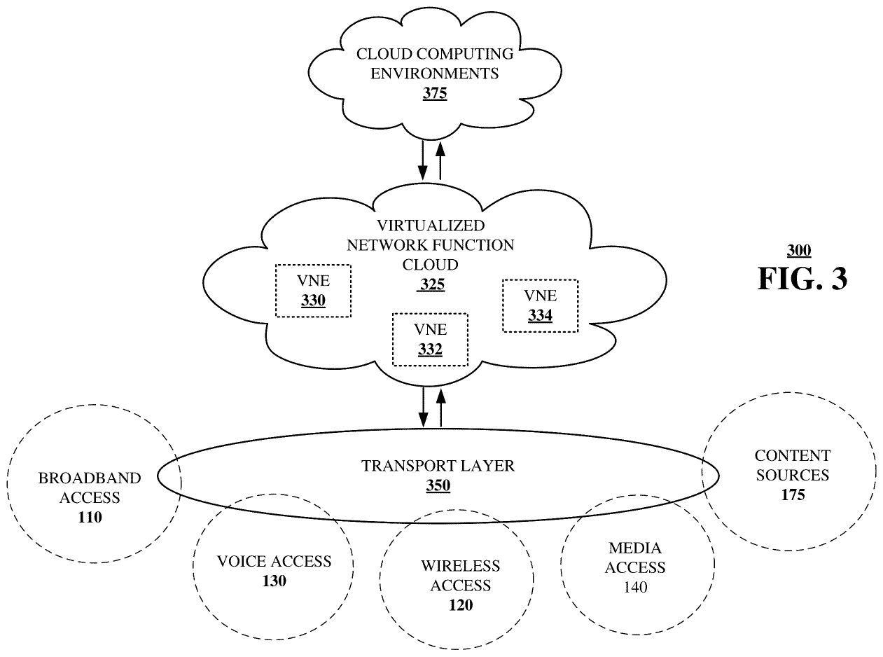

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 200b presented in FIGS. 1, 2A, and 2B. For example, the virtualized communication network 300 can facilitate, in whole or in part, obtaining a request, identifying, based on the obtaining of the request, parameters pertaining to the request, analyzing the request relative to the parameters to identify at least one sensor that has a capability for providing data relevant to the request, resulting in a first analysis, obtaining, based on the first analysis, at least first data provided by the at least one sensor, analyzing the at least first data relative to a baseline dataset to identify an event pertaining to the request, resulting in a second analysis, and initiating, based on the second analysis, an action. The virtualized communication network 300 can facilitate, in whole or in part, identifying parameters associated with an occurrence of an event represented in data obtained from one or more sensors, wherein the parameters include a location of a request and a timeframe associated with the request, identifying at least a first sensor included in the one or more sensors that was active during the timeframe and has a capability in terms of coverage that includes the location, analyzing data sourced from the at least a first sensor relative to a baseline dataset to identify first data included in the data pertaining to the event, and initiating, based on the analyzing, an action. The virtualized communication network 300 can facilitate, in whole or in part, obtaining, by a processing system including a processor, an orally stated request from a user, identifying, by the processing system and based on the obtaining of the request, context associated with the request, resulting in an identified context, transmitting, by the processing system, the request in conjunction with the identified context to a server, and obtaining, by the processing system and from the server, and based on the transmitting, an identification of an event associated with the request.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

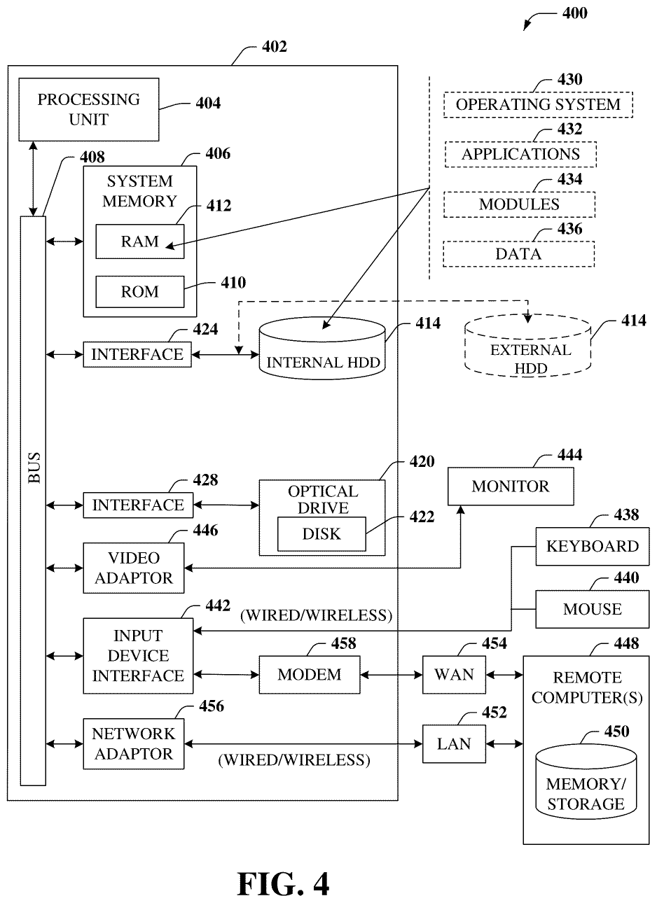

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, obtaining a request, identifying, based on the obtaining of the request, parameters pertaining to the request, analyzing the request relative to the parameters to identify at least one sensor that has a capability for providing data relevant to the request, resulting in a first analysis, obtaining, based on the first analysis, at least first data provided by the at least one sensor, analyzing the at least first data relative to a baseline dataset to identify an event pertaining to the request, resulting in a second analysis, and initiating, based on the second analysis, an action. The computing environment 400 can facilitate, in whole or in part, identifying parameters associated with an occurrence of an event represented in data obtained from one or more sensors, wherein the parameters include a location of a request and a timeframe associated with the request, identifying at least a first sensor included in the one or more sensors that was active during the timeframe and has a capability in terms of coverage that includes the location, analyzing data sourced from the at least a first sensor relative to a baseline dataset to identify first data included in the data pertaining to the event, and initiating, based on the analyzing, an action. The computing environment 400 can facilitate, in whole or in part, obtaining, by a processing system including a processor, an orally stated request from a user, identifying, by the processing system and based on the obtaining of the request, context associated with the request, resulting in an identified context, transmitting, by the processing system, the request in conjunction with the identified context to a server, and obtaining, by the processing system and from the server, and based on the transmitting, an identification of an event associated with the request.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), and an optical disk drive 420, (e.g., reading a CD-ROM disk 422 or, to read from or write to other high-capacity optical media such as the DVD). The HDD 414 and optical disk drive 420 can be connected to the system bus 408 by a hard disk drive interface 424, and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

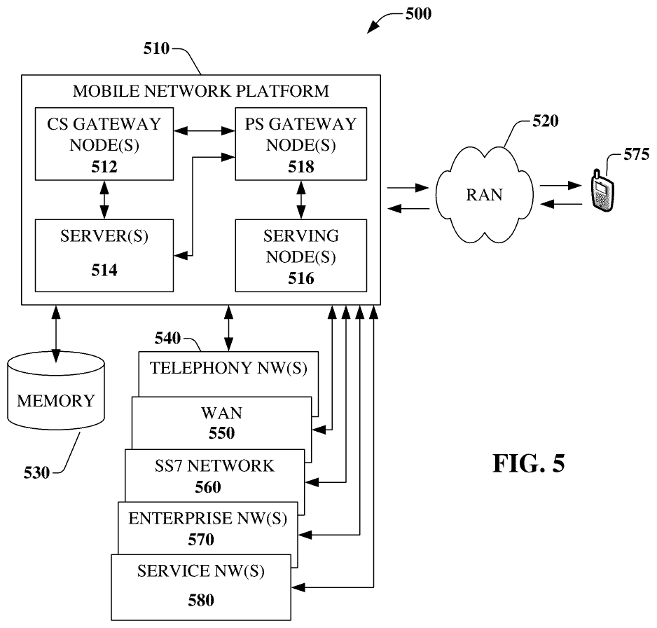

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, obtaining a request, identifying, based on the obtaining of the request, parameters pertaining to the request, analyzing the request relative to the parameters to identify at least one sensor that has a capability for providing data relevant to the request, resulting in a first analysis, obtaining, based on the first analysis, at least first data provided by the at least one sensor, analyzing the at least first data relative to a baseline dataset to identify an event pertaining to the request, resulting in a second analysis, and initiating, based on the second analysis, an action. The platform 510 can facilitate, in whole or in part, identifying parameters associated with an occurrence of an event represented in data obtained from one or more sensors, wherein the parameters include a location of a request and a timeframe associated with the request, identifying at least a first sensor included in the one or more sensors that was active during the timeframe and has a capability in terms of coverage that includes the location, analyzing data sourced from the at least a first sensor relative to a baseline dataset to identify first data included in the data pertaining to the event, and initiating, based on the analyzing, an action. The platform 510 can facilitate, in whole or in part, obtaining, by a processing system including a processor, an orally stated request from a user, identifying, by the processing system and based on the obtaining of the request, context associated with the request, resulting in an identified context, transmitting, by the processing system, the request in conjunction with the identified context to a server, and obtaining, by the processing system and from the server, and based on the transmitting, an identification of an event associated with the request.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

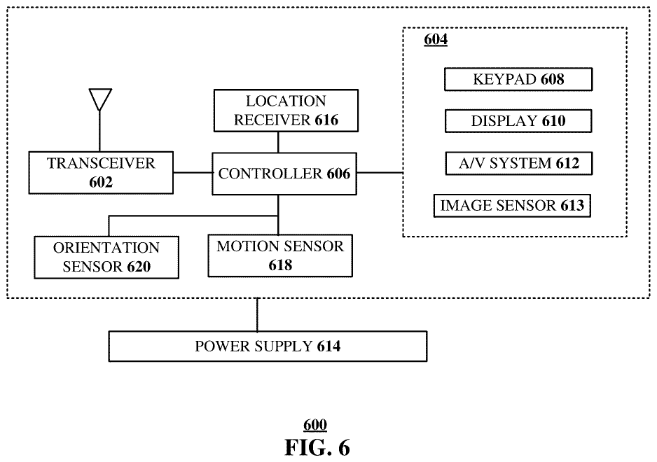

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, obtaining a request, identifying, based on the obtaining of the request, parameters pertaining to the request, analyzing the request relative to the parameters to identify at least one sensor that has a capability for providing data relevant to the request, resulting in a first analysis, obtaining, based on the first analysis, at least first data provided by the at least one sensor, analyzing the at least first data relative to a baseline dataset to identify an event pertaining to the request, resulting in a second analysis, and initiating, based on the second analysis, an action. The computing device 600 can facilitate, in whole or in part, identifying parameters associated with an occurrence of an event represented in data obtained from one or more sensors, wherein the parameters include a location of a request and a timeframe associated with the request, identifying at least a first sensor included in the one or more sensors that was active during the timeframe and has a capability in terms of coverage that includes the location, analyzing data sourced from the at least a first sensor relative to a baseline dataset to identify first data included in the data pertaining to the event, and initiating, based on the analyzing, an action. The computing device 600 can facilitate, in whole or in part, obtaining, by a processing system including a processor, an orally stated request from a user, identifying, by the processing system and based on the obtaining of the request, context associated with the request, resulting in an identified context, transmitting, by the processing system, the request in conjunction with the identified context to a server, and obtaining, by the processing system and from the server, and based on the transmitting, an identification of an event associated with the request.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄. . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining a request;
identifying, based on the obtaining of the request, parameters pertaining to the request;
analyzing the request relative to the parameters to identify at least one sensor that has a capability for providing data relevant to the request, resulting in a first analysis;
obtaining, based on the first analysis, at least first data provided by the at least one sensor;
analyzing the at least first data relative to a baseline dataset to identify an event pertaining to the request, resulting in a second analysis; and
initiating, based on the second analysis, an action.

2. The device of claim 1, wherein the parameters include an identification of a location of the request.

3. The device of claim 1, wherein the parameters include a timeframe associated with the request.

4. The device of claim 3, wherein the timeframe includes a first time period that is prior to an occurrence of the event.

5. The device of claim 4, wherein the obtaining of the request occurs subsequent to the occurrence of the event.

6. The device of claim 4, wherein the timeframe includes a second time period that is subsequent to the occurrence of the event.

7. The device of claim 3, wherein the timeframe is specified via a user-generated input.

8. The device of claim 1, wherein the at least one sensor includes a first sensor and a second sensor, and wherein the at least first data includes the first data provided by the first sensor and second data provided by the second sensor.

9. The device of claim 1, wherein the at least first data includes audio data, video data, motion sensor data, pressure sensor data, touch sensor data, light sensor data, temperature sensor data, wind sensor data, or any combination thereof.

10. The device of claim 1, wherein the initiating of the action includes saving the at least first data as part of a record in association with the event.

11. The device of claim 10, wherein access to the record is protected via a credential.

12. The device of claim 1, wherein the initiating of the action includes generating and transmitting a response to a communication device of a user associated with the request.

13. The device of claim 12, wherein the response includes an indication of the second analysis.

14. The device of claim 1, wherein the initiating of the action includes initiating a purchase of a product or a service, initiating a data transaction, initiating a communication session, or any combination thereof.

15. The device of claim 1, wherein the event includes an emergency, and wherein the initiating of the action includes providing directions to a first responder to address the emergency.

16. A non-transitory machine-readable medium, comprising executable instructions that, when executed by a processing system including a processor, facilitate performance of operations, the operations comprising:
identifying parameters associated with an occurrence of an event represented in data obtained from one or more sensors, wherein the parameters include a location of a request and a timeframe associated with the request;
identifying at least a first sensor included in the one or more sensors that was active during the timeframe and has a capability in terms of coverage that includes the location;
analyzing data sourced from the at least a first sensor relative to a baseline dataset to identify first data included in the data pertaining to the event; and
initiating, based on the analyzing, an action.

17. The non-transitory machine-readable medium of claim 16, wherein the operations further comprise:
obtaining the request from an application executed by a communication device,
wherein the obtaining of the request occurs subsequent to the occurrence of the event.

18. The non-transitory machine-readable medium of claim 16, wherein the initiating of the action includes generating a record of the event based on the analyzing of the data sourced from the at least a first sensor.

19. A method, comprising:
obtaining, by a processing system including a processor, an orally stated request from a user;
identifying, by the processing system and based on the obtaining of the request, context associated with the request, resulting in an identified context;
transmitting, by the processing system, the request in conjunction with the identified context to a server; and
obtaining, by the processing system and from the server, and based on the transmitting, an identification of an event associated with the request.

20. The method of claim 19, wherein the identifying of the context is based on soliciting information from the user, and wherein the identification of the event is based on an analysis of sensor data that is obtained from a plurality of sensors.
